(19) United States
(12) Patent Application Publication
(10) Pub. No.: US 2026/0243621 A1
(43) Pub. Date: Aug. 20, 2026

(54) METHOD OF ASSEMBLING AND TESTING A PRESSURIZED CONSUMER PRODUCT

(71) Applicant: The Gillette Company LLC, Boston, MA (US)

(72) Inventor: Frederik Cornelius Olivier, Reading (GB)

(21) Appl. No.: 19/054,576

(22) Filed: Feb. 14, 2025

(51) Int. Cl. G01M 3/00; B65D 83/00

(52) U.S. Cl. CPC G01M 3/002; B65D 83/771

(57) ABSTRACT

A method of assembling and testing a consumer product by sealing a liner around a body of a valve. A fluid dispensing assembly is formed by sealing the liner and at least a portion of the valve within a container. The container is pressurized. The liner is filled with a liquid. A heat source is applied to the fluid dispensing assembly. The fluid dispensing assembly is cooled by removing the fluid dispensing assembly from the heat source. The temperature of the fluid dispensing assembly is measured after the removing the heat source. The temperature of the fluid dispensing assembly is compared to a predetermined temperature.

### FIELD OF THE INVENTION

The present invention relates generally to methods for assembling and testing consumer products that fluidly dispense material under pressure and more particularly, to assembling and testing pressurized containers having a bag of dispensable material.

### BACKGROUND OF THE INVENTION

In general, it is known to employ a flexible liner within a pressurized container. Compositions to be dispensed by the containers reside within the flexible liner. A gas is injected into the container, which surrounds the flexible liner to aid in the dispensing of the composition. The gas further aids to collapse the flexible liner upon composition usage, so that there is complete or near complete exhaustion of the composition.

In a typical manufacturing sequence, a liner (e.g., sleeve or bag) and container are separately manufactured and then pre-assembled. For example, a valve is then inserted and sealed within an opening in a neck region of the liner. The liner and valve sub-assembly is inserted into the container. The can is pressurized with gas as the valve is crimped and sealed to the can. A composition is then filled into the liner through the valve. An improper seal between the valve and liner can lead to a portion of the composition leaking from the sealed area. In addition, the liner itself may have holes or be otherwise compromised. Such leakage is very undesirable and results in failure of the composition to properly dispense from the container leading to consumer complaints. The leakage is typically undetectable during manufacturing because the filled liner is sealed within the container and thus not visible and cannot be inspected. However, when a consumer attempts to dispense the composition, the composition may come out very slowly (commonly known as drooling), or not at all. One hundred percent testing every single assembly would not only be very time consuming but would waste an amount of composition that could otherwise be used in its intended manner. Accordingly, there is a need for a non-destructive test method that does not waste an amount of composition.

Despite the use of known assembling and inspection techniques, there remains a need to further modify the assembly and inspection of pressurized cans having an inner bag to provide a more accurate, efficient and cost effective way to detect defects.

### SUMMARY OF THE INVENTION

In one aspect, the invention features, in general, a method of assembling and testing a consumer product by sealing a liner around a body of a valve. A fluid dispensing assembly is formed by sealing the liner and at least a portion of the valve within a container. The container is pressurized. The liner is filled with a liquid. A heat source is applied to the fluid dispensing assembly. The fluid dispensing assembly is cooled by removing the fluid dispensing assembly from the heat source. The temperature of the fluid dispensing assembly is measured after the removing the heat source. The temperature of the fluid dispensing assembly is compared to a predetermined temperature.

In another aspect, the invention features, in general, a method of assembling and testing a consumer product by sealing a liner around a body of a valve. A fluid dispensing assembly is formed by sealing the liner and at least a portion of the valve within a container. The container is pressurized. The liner is filled with a liquid. A temperature of the fluid dispensing assembly is changed. The temperature of the fluid dispensing assembly is measured after said changing the temperature. The temperature of the fluid dispensing assembly is compared to a predetermined temperature.

### BRIEF DESCRIPTION OF THE DRAWINGS

FIG. 1 is a perspective view of one possible embodiment of a pressurized consumer product for fluidly dispensing a composition.

FIG. 2 is a side view of one possible embodiment of a fluid dispensing assembly of the pressurized consumer product of FIG. 1.

FIG. 3 is a schematic elevational view showing steps in a process for assembling the fluid dispensing assembly of FIG. 2.

FIG. 4 is a schematic elevational view showing steps in a process for testing the fluid dispensing assembly of FIG. 2.

### DETAILED DESCRIPTION OF THE INVENTION

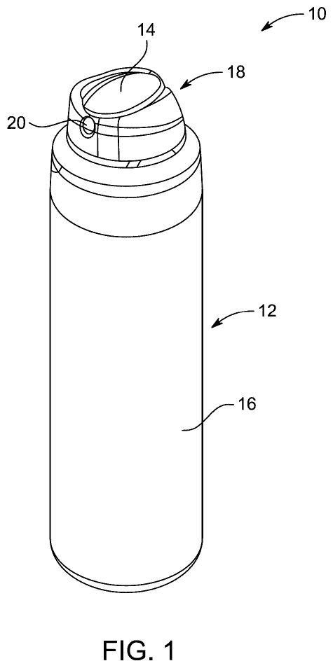

Referring to FIG. 1, a perspective view of one possible embodiment of a pressurized consumer product 10 for fluidly dispensing a composition. The composition may be a personal care composition, such as a shave prep, shampoo, conditioner, sunscreen, deodorant, and antiperspirant. However, it is understood it may also include any fluid composition, such as, insect repellant, surface cleaners, adhesives and paints. In certain embodiments, the pressurized consumer product 10 may include a fluid dispensing assembly 12. An actuator 14, such as a button, may be mounted to the fluid dispensing assembly 12. The fluid dispensing assembly 12 may include a container 16 that comprises metal (e.g., aluminum and steel) and/or plastic material (e.g., ABS and polyethyleneterephthalate) that can sufficiently resist pressure within the pressurized consumer product 10. The actuator 14 may be part of a cap assembly 18 that includes a dispense opening 20 in fluid communication with the actuator 14.

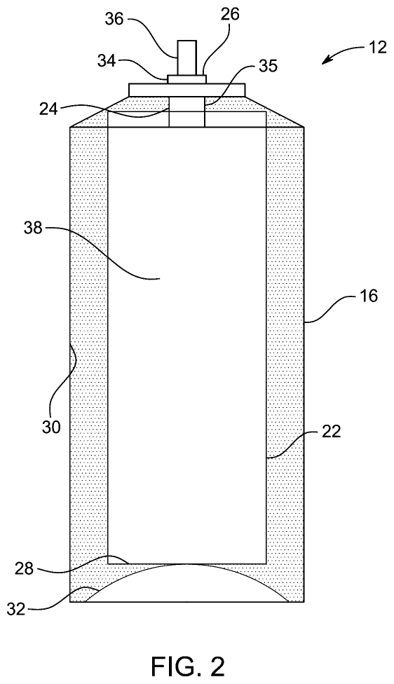

Referring to FIG. 2, a side view of one possible embodiment of the fluid dispensing assembly 12 is illustrated that may be incorporated into the pressurized consumer product 10 of FIG. 1. The fluid dispensing assembly 12 may include a liner 22 (e.g., a bag or sleeve) that has a first end 24 that receives a valve 26 and a second end 28 that is closed (e.g., sealed closed). The liner 22 may be positioned within the container 16. In certain embodiments, the liner 22 may be spaced apart from an inner wall 30 of the container 16. The liner 22 (e.g., the second end 28) may also be spaced apart from an inner lower surface 32 of the container 16. The container 16 may be sealed around a body 34 of the valve 26 in an airtight manner (e.g., heat sealing, ultrasonic welding and adhesives). The valve 26 may include a stem 36 that extends from the body 34 and that is positioned externally of the container 16. The valve 26 may have an end portion 35 that is sealed within the liner 22. For example, the end portion 35 of the valve 26 may be sealed within the first end 24 of the liner 22 by press fitting, crimping, heat sealing, ultrasonic welding, metal deformation crimping or clinching, screw-on, adhesives, spin-welding, and clamping. Accordingly, the end portion 35 may be position within the container 16. The liner 22 may be filled with a fluid composition 38. In certain embodiments, the fluid composition 38 may include a blowing agent; however, a blowing agent is not necessary. The actuator 14 of FIG. 1 may be mounted to the stem 36. The stem 36 and the actuator 14 (FIG. 1) may be in fluid communication to allow the composition 38 to exit through the dispense opening 20 (FIG. 1).

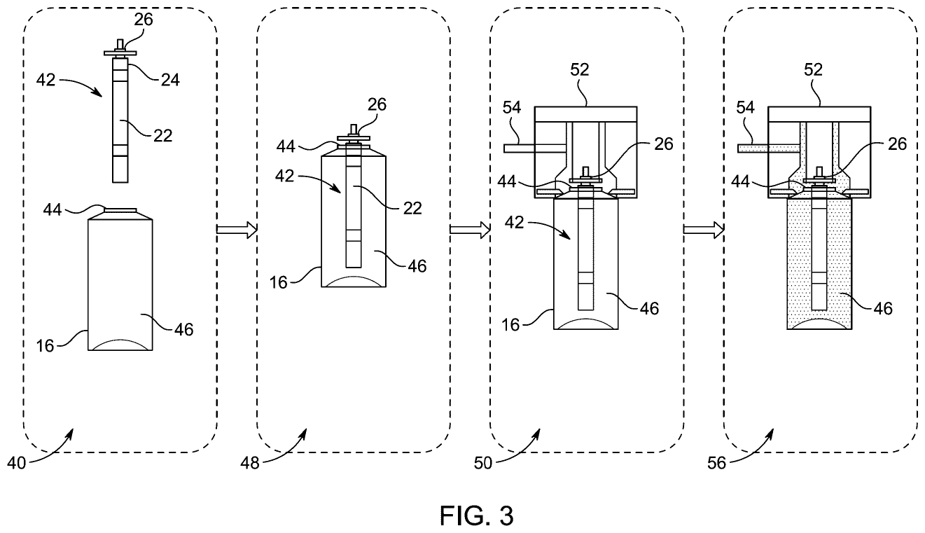

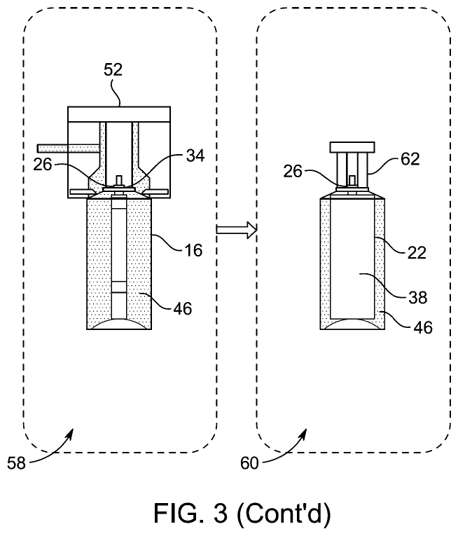

Referring to FIG. 3 a schematic elevational view is shown illustrating steps in a process for assembling the fluid dispensing assembly 12 of FIG. 2. In step 40, the valve 26 (e.g., the end portion 35, shown in FIG. 3) may be sealed (e.g., via heat sealing) within the first end 24 of the liner 22 resulting in a liner preassembly 42. It is understood that the liner preassembly 42 may be performed as a separate step at a separate manufacturing location. For example, a bulk quantity of liner preassemblies 42 may be shipped to an assembly site for further processing. The liner preassembly 42 may be inserted into an opening 44 of the container 16. The container 16 may define a cavity 46 dimensioned to receive at least the liner 22 of the liner pre-assembly 42.

As shown in step 48, the liner 22 of the liner preassembly 42 may be positioned with the cavity 46 and a portion of the valve 26 may be positioned in the opening 44 of the container 16. In certain embodiments, the cavity 46 may have a volume of about 75 mL to about 500 mL depending on the desired amount of the composition 38 to be sold. As shown in step 50, a filling apparatus 52 may then engage the valve 26 and lift the valve 26 partially out of the opening 44 of the container 16, thus allowing air (from an air supply line 54) to flow between the valve 26 and the opening 44 of the container 16, filling and pressurize the cavity 46. The filling apparatus 52 may create an airtight seal against the container 16 to facilitate filling the cavity 46 with air, as shown in step 56. It is understood the filling apparatus 52 may accomplish more assembly operations than filling, such as assembly and sealing operations.

After the cavity 46 is filled to the desired pressure, the filling apparatus 52 may place the valve 26 (e.g., the body 34) within the opening 44 to facilitate sealing of the valve 26, as shown in step 58. The filling apparatus 52 may seal (e.g., via crimping) at least a portion of the valve 26 (e.g., the body 34) within the opening 44 of the container 16 to prevent air from entering or escaping the cavity 46, once a desired pressure is reached within the cavity 46. In certain embodiments, the cavity 46 may be pressurized to about 1.25 bar to about 2.0 bar, depending on the desired size of the container 16. The cavity 46 may be filled with ambient air (e.g., about 22 C to about 27 C). However, it is understood that other atmospheric gases may be used, such as carbon dioxide.

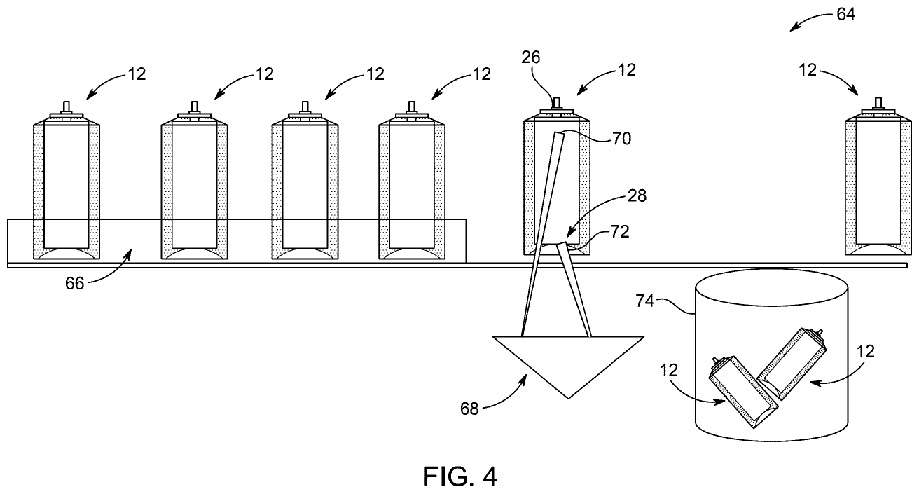

As shown in step 60, a composition filling apparatus 62 may then fill the liner 22 through the valve 26 with the desired composition 38, thus increasing the pressure within the cavity 46. In certain embodiments, the pressure within the cavity 46 may be about 3 bar to about 7 bar after the liner 22 is filled with the composition 38. Once the filling (i.e., step 60) is complete, the resulting fluid dispensing assembly 12 (FIG. 4) may be ready for further processing. Typically, the fluid dispensing assembly 12 may go through additional assembly steps after filling is complete, such as the attachment of the cap assembly 18 with the actuator 14 (FIG. 1). However, a quality control process would be advantageous to discard any defective fluid dispensing assemblies 12 prior to additional assembly steps.

Referring to FIG. 4, one possible embodiment of a quality control process 64 is illustrated. A heat source may be applied to one or more of the fluid dispensing assemblies 12. For example, one or more of the fluid dispensing assemblies 12 may be exposed to a heat source (e.g., placed in a water bath 66). In certain embodiments, a temperature of the water bath may be heated to about 50 C to about 65 C and more preferably about 55 C to about 60 C. Although the water bath 66 is shown as a heat source, it is understood other methods and apparatuses may be used to raise the temperature of the fluid dispensing assemblies 12, such as a heating chamber (e.g., an oven). The one or more fluid dispensing assemblies 12 may remain in the water bath for approximately 1 minute to 10 minutes, preferably about 2 minutes to about 5 minutes and more preferably about 2.5 minutes to 3.5 minutes. The however, the length of time in the water bath 66 may vary depending on the size of the fluid dispensing assembly 12 and the temperature of the water bath 66.

The one or more fluid dispensing assemblies 12 may exit the water bath 66 and exposed to ambient conditions prior to measuring a temperature of the fluid dispensing assembly 12. For example, approximately 2 seconds to 20 seconds and preferably about 3 seconds to about 10 seconds after exiting the water bath 66, the temperature of the fluid dispensing assembly 12 may be measured. It is understood the time between exiting the water bath and the measurement of the temperature may vary based on desired line speed. The temperature of the fluid dispensing assembly 12 may be measured in-line as part of a continuous inspection process and to make sure any temperature differential is captured in a timely manner to identify defects. In certain embodiments, an infrared sensor 68 may be used to measure a temperature in a first region 70 and a second region 72 of the fluid dispensing assembly 12. It is understood various types of non-contact temperature sensors may be used including, but not limited to thermal sensors, infrared thermometers, pyrometers, and thermographic cameras. The first region 70 may be located towards the valve 26 of the fluid dispensing assembly 12, as the seal between the liner 22 and the valve 26 is a typical failure area. The second region 72 may be towards the second end 28 of the liner 22 that is opposite the valve 26, as the liner 22 is typically sealed in this area and may also be prone to failure.

It has been observed that a temperature of the first region 70 and/or the second region 72 is greater for a defective fluid dispensing assembly 12 (e.g., having a seal failure resulting in leakage of the composition 38) compared to a non-defective fluid dispensing assembly 12. The non-defective fluid dispensing assemblies 12 that do not have a seal failure cool faster. Accordingly, if a predetermined temperature is reached for either the first region 70 and/or the second region 72, the defective fluid dispensing assembly 12, which have a higher temperature, may be discarded or otherwise separated from the non-defective fluid dispensing assemblies 12 that are below the predetermined temperature. For example, the defective fluid dispensing assemblies 12 maybe automatically transferred to a scrap bin 74. In certain embodiments, the predetermined temperature may be about 29 C to about 34 C. The predetermined temperature may be different depending on the volume of the cavity 46 and if the temperature is taken at the first region 70 or the second region 72. The predetermined temperature for the first region may be greater than the predetermined temperature for the second region 72. For example, for 200 mL volume, the predetermined temperature for the first region 70 may be 31 C (+/−0.5 C) and the predetermined temperature for the second region 72 may be 29.5 C (+/−0.5 C). A smaller volume may have a higher predetermined temperature. For example, for a 75 mL volume, the predetermined temperature for the first region 70 may be 33.5 C (+/−0.5 C) and the predetermined temperature for the second region 72 may be 33 C (+/−0.5 C).

The air space in the container 16 (i.e., the cavity 46) will both increase in temperature when the fluid dispensing assembly 12 is placed in the water bath 66 and decrease in temperature once the fluid dispensing assembly 12 is removed from the water bath. The temperature changes of the air space within the container 16 (i.e., the cavity 46) will change (both during heating and cooling) faster than the composition 38 changes temperature. Accordingly, a temperature difference is observed between the fluid dispensing assemblies 12 that have leakage of the composition 38 compared to fluid dispensing assemblies 12 that have no leakage of the composition 38. The temperature of the water bath 66, the duration the fluid dispensing assemblies 12 are in the water bath 66 and the amount of time the fluid dispensing assemblies 12 are allowed to cool may are all variable that may affect observed temperature difference between the fluid dispensing assemblies 12 having leakage of the composition 38 and the fluid dispensing assemblies 12 with no leakage of the composition 38. For example, the fluid dispensing assemblies 12 having leakage may be cooler than fluid dispensing assemblies 12 with no leakage if the composition 38 does not heat up close enough to the temperature of the water bath 66 and the air within the cavity 46 does heat up to close to or at the temperature of the water bath 66. Accordingly, if temperature is measured immediately after exiting the water bath 66 the temperature of the fluid dispensing assemblies 12 having leakage will be cooler because of the cooler temperature of the leaking composition being measured. In another example, the fluid dispensing assemblies 12 having leakage may be hotter than the fluid dispensing assemblies 12 with no leakage if the composition 38 and the air within the cavity 46 heat up to close to or at the temperature of the water bath 66. Accordingly, if temperature is measured shortly after exiting the water bath 66 the temperature, thus allowing the air temperature within the cavity to cool down, the fluid dispensing assemblies 12 having leakage will be hotter because the leaking composition would not have cooled down.

The dimensions and values disclosed herein are not to be understood as being strictly limited to the exact numerical values recited. Instead, unless otherwise specified, each such dimension is intended to mean both the recited value and a functionally equivalent range surrounding that value. Dimensions should not be held to an impossibly high standard of metaphysical identity that does not allow for discrepancies due to typical manufacturing and measuring tolerances. Therefore, the term “about” should be interpreted as being within typical manufacturing and measuring tolerances.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of assembling and testing a consumer product comprising:
sealing a liner around a body of a valve;
forming a fluid dispensing assembly by sealing the liner and at least a portion of the valve within a container;
pressurizing the container;
filling the liner with a liquid;
applying a heat source to the fluid dispensing assembly;
cooling the fluid dispensing assembly by removing the fluid dispensing assembly from the heat source;
measuring the temperature of the fluid dispensing assembly after said removing the heat source; and
comparing the temperature of the fluid dispensing assembly to a predetermined temperature.

2. The method of claim 1 further comprising discarding the fluid dispensing assembly if the measured temperature of the fluid dispensing assembly is at or above the predetermined temperature.

3. The method of claim 1 further comprising discarding the fluid dispensing assembly if the measured temperature of the fluid dispensing assembly is at or below the predetermined temperature.

4. The method of claim 1 wherein said applying a heat source comprises placing the fluid dispensing assembly in a heated water bath.

5. The method of claim 4 wherein said placing the fluid dispensing assembly in a heated water bath comprises placing the fluid dispensing assembly in a heated water bath for about 1 minute to about 10 minutes.

6. The method of claim 4 further comprising heating the water bath to about 50 C degrees to about 65 C degrees.

7. The method of claim 4 further comprising heating the water bath to about 55 degrees to about 60 degrees.

8. The method of claim 1 wherein said cooling comprises exposing the fluid dispensing assembly to ambient air temperature.

9. The method of claim 1 wherein said cooling comprises exposing the fluid dispensing assembly to ambient air temperature for about 3 seconds to about 20 seconds.

10. The method of claim 1 wherein said measuring is performed in-line.

11. The method of claim 1 wherein said measuring comprises measuring the temperature of the fluid dispensing assembly with an infrared sensor.

12. The method of claim 1 wherein the predetermined temperature is 29 C to about 34 C.

13. The method of claim 1 wherein said measuring comprises measuring a temperature of the fluid dispensing assembly in a first region of the fluid dispensing assembly and a second region of the fluid dispensing assembly.

14. The method of claim 11 wherein comparing the temperature of the fluid dispensing assembly comprises comparing the temperature of the first region to a first predetermined temperature and comparing the temperature of the second region to a second temperature that is different than the first temperature.

15. The method of claim 1 further comprising mounting a cap assembly to the fluid dispensing assembly if the measured temperature of the fluid dispensing assembly is at or above the predetermined temperature.

16. A method of assembling and testing a consumer product comprising:
sealing a liner around a body of a valve;
forming a fluid dispensing assembly by sealing the liner and at least a portion of the valve within a container;
pressurizing the container;
filling the liner with a liquid;
changing a temperature of the fluid dispensing assembly;
measuring the temperature of the fluid dispensing assembly after said changing the temperature; and
comparing the temperature of the fluid dispensing assembly to a predetermined temperature.

17. The method of claim 16 wherein said measuring comprises measuring a temperature of the fluid dispensing assembly in a first region of the fluid dispensing assembly and a second region of the fluid dispensing assembly.

18. The method of claim 16 wherein further comprising discarding the fluid dispensing assembly if the measured temperature of the fluid dispensing assembly is at or above the predetermined temperature.

19. The method of claim 16 wherein further comprising discarding the fluid dispensing assembly if the measured temperature of the fluid dispensing assembly is at or below the predetermined temperature.

20. The method of claim 16 wherein said changing the temperature comprises placing the fluid dispensing assembly in a heated water bath.
